(19) United States
(12) Patent Application Publication
(10) Pub. No.: US 2015/0074450 A1
(43) Pub. Date: Mar. 12, 2015

(54) HARD DISK DRIVE (HDD) EARLY FAILURE DETECTION IN STORAGE SYSTEMS BASED ON STATISTICAL ANALYSIS

(71) Applicant: International Business Machines Corporation, Armonk, NY (US)

(72) Inventors: Lawrence C. Blount, Tucson, AZ (US); Thorsten Muehge, Budenheim (DE); Erik Rueger, Ockenheim (DE); Joerg Weyerhaeuser, Grolsheim (DE)

(73) Assignee: International Business Machines Corporation, Armonk, NY (US)

(21) Appl. No.: 14/022,087

(22) Filed: Sep. 9, 2013

(51) Int. Cl. G06F 11/07

(52) U.S. Cl. CPC G06F 11/0727
USPC 714/6.1

(57) ABSTRACT

In one embodiment, a system includes a processor and logic integrated with and/or executable by the processor, the logic being configured to detect a failure event indicating possible failure of a storage device, initiate a rebuild for the storage device which experienced the failure event, receive information about the storage device which experienced the failure event, and apply a set of statistical process control rules to the information to determine whether the failure event is statistically abnormal. Other systems, methods, and computer program products for providing early warning of storage device failure are also described in additional embodiments.

### BACKGROUND

The present invention relates to storage systems, and more particularly, this invention relates to hard disk drive (HDD) early failure detection using statistical analysis in storage systems.

The amount of stored information used in all types of industry is steadily increasing. As a consequence of this increase in storage demand, the storage capacity of storage systems and subsystems is increasing, along with the capacity of individual HDDs used in the storage systems and subsystems.

In order to protect storage systems and subsystems from data loss, redundancies are incorporated into the design of these systems, such as redundant array of independent disks (RAID) to protect against the loss of one or more individual HDDs, storage mirroring between two or more storage subsystems to protect against a loss of a complete storage subsystem, disaster recovery data centers configured to protect against loss of an entire data center, and various other backup solutions that may be implemented on a per-HDD, per-storage subsystem, and/or per-data center basis.

Present storage solutions may already have more than one thousand HDDs per storage subsystem, and this number continues to increase as the demand for storage increases. In addition, the area density of magnetic bits is also increasing. In turn the probability of a loss of data stored to a HDD is also increasing.

### BRIEF SUMMARY

In one embodiment, a system includes a processor and logic integrated with and/or executable by the processor, the logic being configured to detect a failure event indicating possible failure of a storage device, initiate a rebuild for the storage device which experienced the failure event, receive information about the storage device which experienced the failure event, and apply a set of statistical process control rules to the information to determine whether the failure event is statistically abnormal.

According to another embodiment, a computer program product for providing early warning of storage device failure includes a computer readable storage medium having program code embodied therewith, the program code readable/executable by a processor to detect a failure event indicating possible failure of a storage device, initiate a rebuild for the storage device which experienced the failure event, receive information about the storage device which experienced the failure event, and apply a set of statistical process control rules to the information to determine whether the failure event is statistically abnormal.

In another embodiment, a method for providing early warning of storage device failure includes detecting a failure event indicating possible failure of a storage device, wherein the storage device is a hard disk drive, initiating a rebuild for the storage device which experienced the failure event, receiving information about the storage device which experienced the failure event, and applying a set of statistical process control rules to the information to determine whether the failure event is statistically abnormal using a statistical analysis module coupled to a management controller which manages a plurality of storage controllers including a storage controller which is configured to manage the storage device which experienced the failure event, wherein the information about the storage device which experienced the failure event includes at least one of: storage device position, storage device manufacturer, manufacturing date, batch and/or serial number, storage device disk pool information, storage device install timestamp, and storage device failure code and failed timestamp if the storage device has actually failed.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 depicts a cloud computing node, according to one embodiment.

FIG. 2 depicts a cloud computing environment, according to one embodiment.

FIG. 3 depicts abstraction model layers, according to one embodiment.

FIG. 4 shows a system for providing early warning of storage device failure, according to one embodiment.

FIG. 5 shows a flowchart of a method according to one embodiment.

FIG. 6 shows a flowchart of a method according to one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an,” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several embodiments of hard disk drive (HDD) early failure detection in storage systems and/or subsystems using statistical analysis of actual HDDs installed and operating in the storage systems and/or subsystems.

In one general embodiment, a system includes a processor and logic integrated with and/or executable by the processor, the logic being configured to detect a failure event indicating possible failure of a storage device, initiate a rebuild for the storage device which experienced the failure event, receive information about the storage device which experienced the failure event, and apply a set of statistical process control rules to the information to determine whether the failure event is statistically abnormal.

According to another general embodiment, a computer program product for providing early warning of storage device failure includes a computer readable storage medium having program code embodied therewith, the program code readable/executable by a processor to detect a failure event indicating possible failure of a storage device, initiate a rebuild for the storage device which experienced the failure event, receive information about the storage device which experienced the failure event, and apply a set of statistical process control rules to the information to determine whether the failure event is statistically abnormal.

In another general embodiment, a method for providing early warning of storage device failure includes detecting a failure event indicating possible failure of a storage device, wherein the storage device is a hard disk drive, initiating a rebuild for the storage device which experienced the failure event, receiving information about the storage device which experienced the failure event, and applying a set of statistical process control rules to the information to determine whether the failure event is statistically abnormal using a statistical analysis module coupled to a management controller which manages a plurality of storage controllers including a storage controller which is configured to manage the storage device which experienced the failure event, wherein the information about the storage device which experienced the failure event includes at least one of: storage device position, storage device manufacturer, manufacturing date, batch and/or serial number, storage device disk pool information, storage device install timestamp, and storage device failure code and failed timestamp if the storage device has actually failed.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for loadbalancing between clouds).

A cloud computing environment is service oriented with a focus on statelessness, low coupling, modularity, and semantic interoperability. At the heart of cloud computing is an infrastructure comprising a network of interconnected nodes.

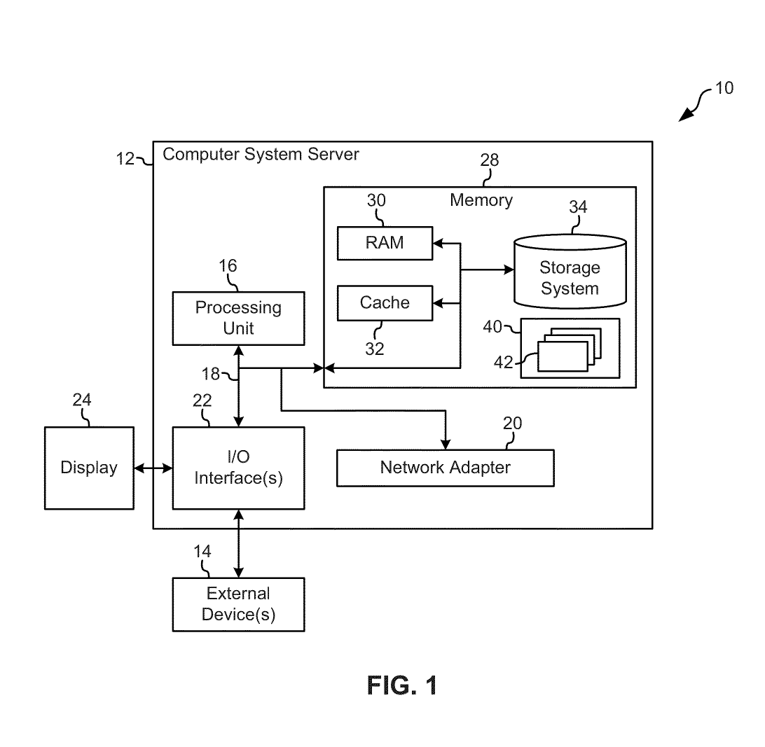

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, redundant array of independent disks (RAID) systems, tape drives, and data archival storage systems, etc.

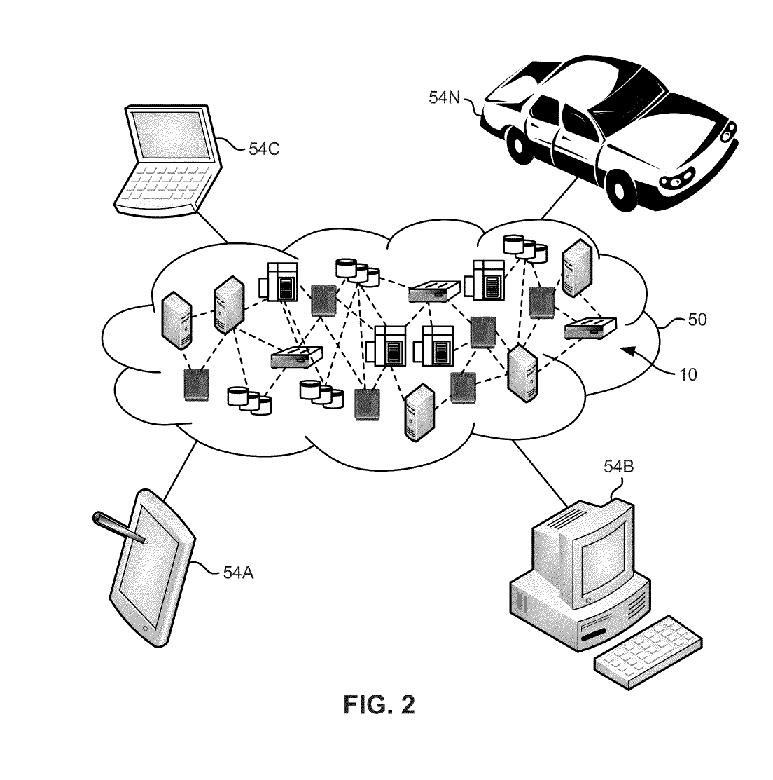

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

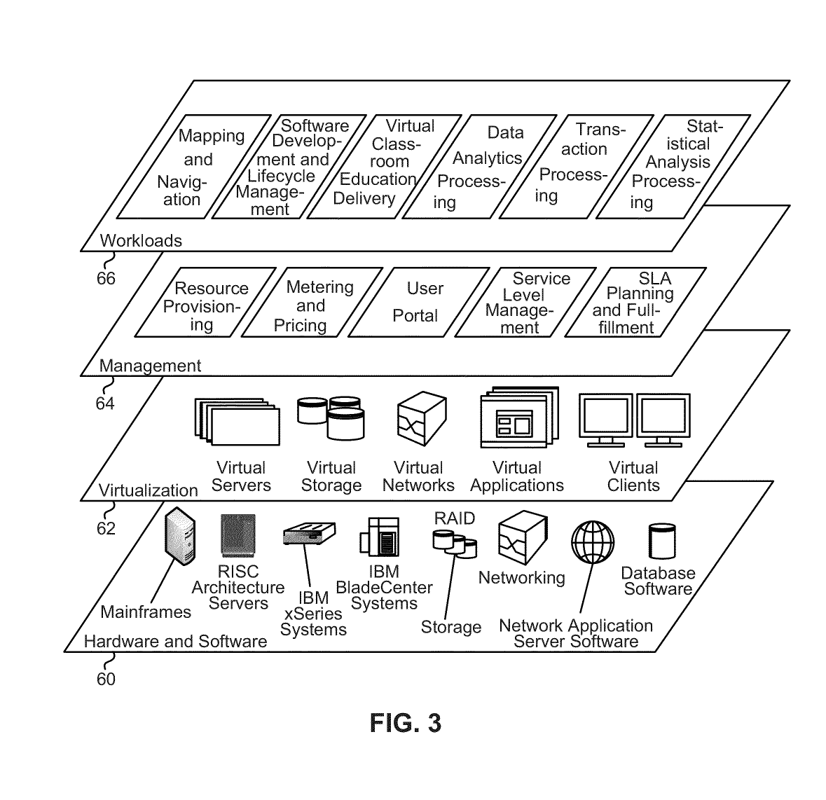

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 62 provides an abstraction layer from which the following examples of virtual entities may be provided: virtual servers; virtual storage; virtual networks, including virtual private networks: virtual applications and operating systems; and virtual clients.

In one example, management layer 64 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 66 provides examples of functionality for which the cloud computing environment may be utilized. Examples of workloads and functions which may be provided from this layer include: mapping and navigation; software development and lifecycle management; virtual classroom education delivery; data analytics processing; transaction processing: statistical analysis processing; etc.

Some attempts have been made in order to minimize storage device (such as a HDD, optical drive, solid state storage device, or some other storage device) failure in systems and subsystems. One conventional approach relies on an analytic approach to predict against storage device failures in order to mitigate the impact of the loss of a storage device (e.g., data loss). In one conventional approach, various parameters are observed by microcode in the storage device to predict upcoming failures. These parameters may include storage device read/write error rates, storage device operating temperature, and HDD spin-up time and/or storage device access time. The storage device read/write error rates describe how many read or write errors occur over a given time period, such as 10 ms, 100 ms, 1 second, 2 seconds, 5 seconds, 1 minute, 30 minutes, 1 day, etc.

However, storage device failures are very sensitive to other externally driven parameters which are not conventionally tracked. These externally driven parameters may include data center temperature (a two Kelvin temperature difference may have a huge impact to storage device failure rates), corrosion which may be introduced by aggressive (acidic or basic) atmospheres within the data center, voltage fluctuations in the power supply to the storage devices, storage device operating time (increased failure rates have been found to be strongly correlated to increased operating time), manufacturing vintages, etc.

The manufacturing vintage refers to the make, model, and batch of each storage device. By knowing the vintage of the storage device, a correlation may be made between other storage device failures of the same vintage and a currently operating storage device such that it may be foreseen that the same vintage may experience the same problems as other already failed storage devices.

The use of conventional methods to anticipate storage device failures introduces the following severe challenges that might result in data loss situations. First, the conventional analytic approach does not automatically detect storage device failure rates for each of many different storage subsystems, each storage subsystem possibly having its own storage device failure rate. Second, no warning is provided using the analytical approach when the general level of storage device failures is increasing. When the general level of storage device failures is increasing, the probability of data loss increases tremendously.

Furthermore, conventional methods rely on HDD microcode only to execute the analytical methodology in a system and/or group of HDDs. Each individual HDD's microcode is used to detect a potential upcoming failure of the HDD and in turn migrates any data stored thereto to a safe and secure alternate HDD. Once the migration is complete, the HDD having the high potential for failure is rejected from a disk array, such as a redundant array of independent disks (RAID), utilizing the disk and marked for a hardware replacement. A reliability, availability, serviceability (RAS) module may then be used to initiate communication with an operator, such as a call home. In response to the communication, the operator and/or a field service technician is informed that a failed drive needs to be replaced.

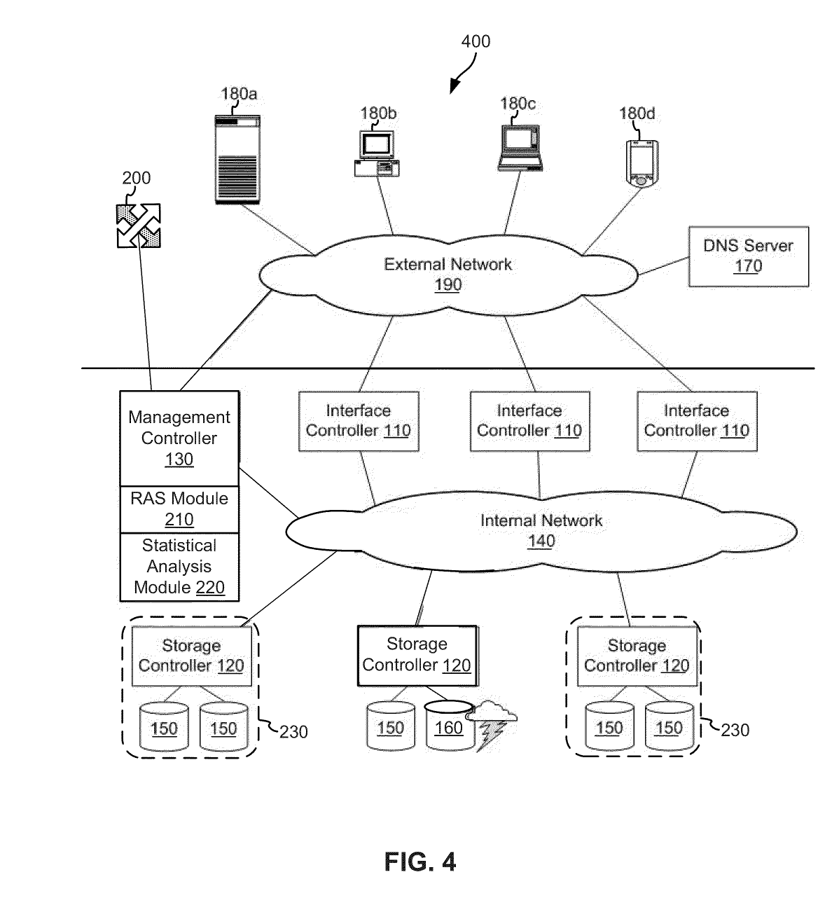

Now referring to FIG. 4, a system 400 configured for providing storage device early failure detection using statistical analysis is shown according to one embodiment. The system 400 may comprise some or all of the elements shown in FIG. 4, in various implementations. In one such embodiment, the system 400 comprises one or more storage controllers 120, each storage controller 120 being configured for communicating with, monitoring, and managing one or more storage devices 150 (such as HDDs) or storage media. In addition, each storage controller 120 is configured for managing storage of data on the one or more storage devices 150. The storage devices 150 connected to a single storage controller 120 may be referred to as a storage subsystem 230. The storage subsystems 230 may be on a one-to-one relationship with the storage controllers 120, or more than one storage subsystem 230 may be managed by a single storage controller 120. Moreover, one or more of the storage controllers 120 is connected to a management controller 130 via an internal network 140, with the management controller 130 being capable of accessing each of the storage controllers 120 directly or indirectly.

The internal network 140 is connected to an external network 190 via one or more interface controllers 110. Additionally, the management controller 130 is also connected to the external network 190 and interfaces with a RAS module 210 and a statistical analysis module 220. The external network 190 may be connected to one or more workstations 180a, 180b, 180c, 180d, etc., and to a domain name system (DNS) server 170. The workstations 180a, 180b, 180c, 180d, etc., may comprise any type of computer, server, mainframe, handheld computing device, portable computing device, module, etc., that is capable of connecting in the external network, via wired or wireless connections, as would be known by one of skill in the art.

The management controller 130 is also configured for interfacing with a communication module 200 which may be capable of communicating with any operator and/or user of the system 400. In one embodiment, the communication module 200 may communicate with an operator via a “Call Home” function, as known in the art.

The statistical analysis module 220 monitors each of the storage devices 150, storage subsystems 230, and any other storage devices connected to the system 400, in one embodiment. The statistical analysis module 220 collects and analyzes information about the storage devices 150, such as discrete event information, status information, performance information, etc. Some discrete event information that may be monitored by and collected by the statistical analysis module 220 includes storage device failure rate, storage device failure code, storage device position, storage device firmware level or revision, storage device install date, storage device failed date, storage subsystem 230 (or disk pool) information, and storage device vendor information.

The storage device failure rate is a parameter which relates to the number of storage device failures per unit of time. The storage device failure code is code which operates on the storage device which indicates potentially threatening (from a failure standpoint) conditions which may cause the storage device to fail. The storage device position is a parameter which relates to where in the system 400 or a storage subsystem 230 the specific storage device 150 is located. The storage device firmware level or revision is a parameter which describes the latest firmware installed on the storage device 150, so that it may be compared to other firmware levels from other storage devices 150 to determine if a pattern is ascertainable regarding one or more specific firmware levels experiencing more failures than normal.

The storage device install date and storage device failed date are parameters which describe when the device was installed, and when it failed, respectively. Of course, there is only a failed date after a storage device 150 has actually failed. This indicates that not only currently active storage devices 150 have information collected and analyzed, but also information regarding any storage device 150 which has ever been used in the system 400 may be used in the statistical analysis methods described herein.

The storage subsystem 230 (or disk pool) information describes the group in which the storage device 150 is installed and how other storage devices in this group have performed. The storage device vendor information is a parameter which describes the vendor, manufacturing date, batch number, etc. This information may be used to determine when a certain batch of storage devices are more prone to failure so that they may be removed from service.

When one or more of the storage devices 150 are HDDs, the information collected may be specific to a HDD, such as HDD failure rate, HDD failure code, HDD position, HDD firmware level, HDD install and/or failed date, disk pool information, and HDD vendor information.

After a sufficient amount of data is collected regarding any of one or more parameters, the statistical analysis module 220 may perform statistical analytic methods to detect early warning signs of storage device (e.g., HDD) failure based on the collected information. As shown in FIG. 4, storage device 160 is indicated as having an increased potential for failure based on analysis by the statistical analysis module 220.

Any suitable statistical analytical methods may be employed, such as well established mathematical methods designed to control manufacturing processes. Such an approach has been introduced by Shewhart in 1920 and later by Deming. In these early designs, the focus was on ensuring a continuous quality of product from a manufacturing process. However, these mathematical methods may be utilized to ensure analyze hard disk drive failures, in order to determine indicia of failure which may be used to provide early warning about future failures.

In the context of storage subsystems, the statistical methods are incorporated into a predictive engine (statistical analysis module 220) that is configured to monitor the various storage devices (and specifically all HDDs) and automatically generate a warning when unusual, abnormal, and/or troublesome behavior or indicia of failure is detected. As an example, such a warning may be generated for any of the following scenarios using general statistical process control mechanisms analyzing information derived or provided from the storage devices (such as attribute data, counts of discrete events, alerts, etc.):
1) average of the failure rate increased for a definite time.
2) failure rate exceeded a predefined threshold.
3) u-chart, p-chart, np-chart, p-chart, etc., and/or any other standard statistical analysis charts as would be understood by one of skill in the art when applied to the information collected for each storage device, groups of storage devices, and/or storage system and subsystems.

The various statistical analysis charts which may be used to analyze the information collected from the storage devices 150 and storage system 400 are not limited to those specifically described herein. Instead, any suitable statistical analysis methodology known in the art may be used to analyze the collected information.

The warning may be originated due to any triggering event and/or detection of any of the following external parameters:
1) a change in temperature (such as an increase) in at least one storage device and/or in a data center comprising storage devices.
2) a change in humidity in at least one storage device and/or in a data center comprising storage devices.
3) at least one storage device having a vintage which has been identified as problematic due to observed failures in other storage devices having the same vintage.
4) detection of corrosion in the data center and/or on one or more parts of at least one storage device.

The warning may now be used as a stimulus to trigger an investigation for potential causes of the warning and in turn prevent severe impacts to the production (ability to store data) of the storage system, subsystem, and/or individual storage devices.

According to another approach, a statistical general increase of error rates for all storage devices 150 in the system 400 may be indicative of a potential failure. Furthermore, the statistical analysis may utilize the entire pool of the collected parameters into account when performing the statistical analysis.

With increasing number of storage devices 150 in each storage subsystem 230, such an approach is increasingly valid for such a system 400 employing these subsystems 230. Because the impact of a general increase of storage device failures is very troubling and disruptive, an automated warning system capable of sending an early warning and thus allow an operator to prevent severe failure scenarios from taking place would be incredibly beneficial.

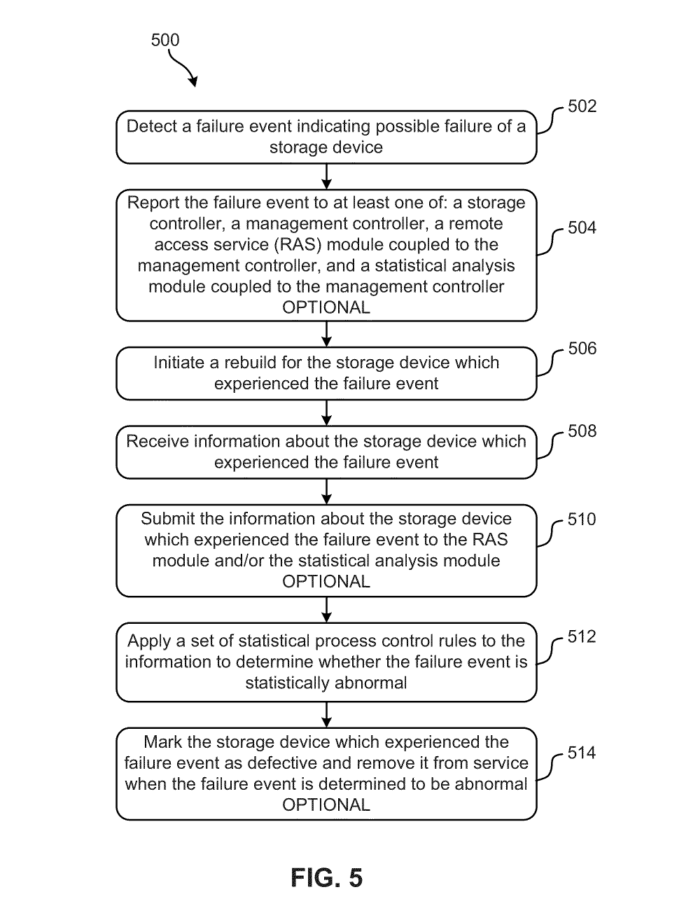

Now referring to FIG. 5, a flowchart of a method 500 for providing early warning of storage device failure is shown, according to one embodiment. The method 500 may be performed in accordance with the present invention in any of the environments depicted in FIGS. 1-4, among others, in various embodiments. Of course, more or less operations than those specifically described in FIG. 5 may be included in method 500, as would be understood by one of skill in the art upon reading the present descriptions.

Each of the steps of the method 500 may be performed by any suitable component of the operating environment. For example, in one embodiment, the method 500 may be partially or entirely performed by a storage controller, a management controller, a statistical analysis module, a RAS module, a processor (such as an ASIC, a FPGA, a CPU, etc.) embodied in a computer or device, a host or server connected to an internal or external network, etc.

As shown in FIG. 5, method 500 may initiate with operation 502, where a failure event indicating possible failure of a storage device is detected. The detection of the failure event may be based on any indicia of failure which is described herein or others known in the art. A non-exhaustive list of possible conditions or information which may be indicative of a storage device failure include, but are not limited to: increase in storage device temperature, increase in data center temperature, increase in read and/or write error rates, storage device vintage issue, detection of corrosion in the storage device and/or the data center, etc.

In optional operation 504, the failure event is reported to at least one of: a storage controller which is configured to manage the storage device which experienced the failure event, a management controller which manages a plurality of storage controllers, a RAS module coupled to the management controller, and a statistical analysis module coupled to the management controller.

In operation 506, a rebuild is initiated for the storage device which experienced the failure event. This rebuild may be initiated by a storage controller which operates within a storage subsystem of the storage device which experienced the failure event, and/or by a management controller which manages or oversees a plurality of storage controllers including the storage controller which is configured to manage the storage device which experienced the failure event. The rebuild procedure utilizes redundancy or some other data backup plan to mitigate data loss and transfer or copy all data from the storage device which experienced the failure event to another storage device to ensure that the data is accessible even if and when the storage device which experienced the failure event eventually (and actually) fails, instead of simply being predicted to fail by the detection of the failure event.

In operation 508, information about the storage device which experienced the failure event is received. This information may be received by any suitable component of the system, such as the storage controller, the management controller, a RAS module, a statistical analysis module, etc. The RAS module may be used to collect and distribute the information to the statistical analysis module or to the management controller. Furthermore, the RAS module and/or the statistical analysis module may be independent of the management controller, or may be sub-modules of the management controller or some other server or controller in the system.

In optional operation 510, information about the storage device which experienced the failure event is submitted to a RAS module and/or a statistical analysis module. The RAS module may be used to collect and distribute the information to the statistical analysis module and/or to the management controller. Furthermore, the RAS module and/or the statistical analysis module may be independent of the management controller, or may be sub-modules of the management controller or some other server or controller in the system.

The information which is provided to the RAS module and/or the statistical analysis module may include information relating to the storage device which experienced the failure event and any system and/or subsystem thereof, such as: storage device position (relative to other storage devices, in a storage subsystem, in the storage system, and in a RAID or array), storage device manufacturer and/or vendor, manufacturing information (including manufacturing date, batch and/or serial number, etc.), storage device failure code, storage device disk pool information, storage device install timestamp, storage device failed timestamp, etc.

In operation 512, a set of statistical process control rules are applied to this information to determine whether the failure event is statistically abnormal. This application of process control rules may be performed by any component of the system, including but not limited to the storage controller, the statistical analysis module, the RAS module, and/or the management controller. When the failure event is determined to be statistically abnormal (outside a predetermined allowable range), an operator may be informed of the failure event in order to allow the operator to investigate the failure event more thoroughly if deemed appropriate.

In optional operation 514, when the failure event is determined to be abnormal, the storage device which experienced the failure event is marked as defective, and removed from service. By abnormal, what is meant is that the failure event is indicative of an imminent or highly probable failure of the storage device in the near future which may be determined based on deviation of one or more parameters from an average of those one or more parameters over a certain period of time, and possibly deviation by one or more (such as three) standard deviations from the mean (e.g., 30). This deviation may be specified by a user, determined using a table of failure events, specified by an algorithm, and/or determined using other techniques known in the art. Furthermore, if the storage device which experienced the failure event is in an array or RAID, another suitable storage device is substituted into the array or RAID in order to continue with the redundancy provided by such a storage structure.

Once the defective storage device is removed from service, it may be further analyzed and tested, and if on further examination it is deemed that the failure event will not lead to a premature failure of the storage device, the storage device may be reinstated into service at a convenient time.

This method 500 may be used in all storage systems and storage subsystems with a large amount (greater than about 250, 500, 750, 1000, etc.) of storage devices (such as HDDs). In one embodiment, the number may be greater than about 500 HDDs. The number may include block storage machines as well as file storage machines.

In addition, method 500 may be implemented in storage virtualization engines like IBM's SAN Volume Controller (SVC), where the statistical analysis module may be used to monitor HDDs for all storage systems across installations, manufacturers, usage, etc. Furthermore, heterogeneous cloud solutions may be monitored as well. In general, method 500 is capable of decreasing the possibility of a severe impact with respect to storage device failures for all storage subsystems, particularly those which rely on HDDs.

Method 500 may be performed by a system, apparatus, computer program product, or in any other way known in the art. In one such embodiment, a system (such as a storage system or storage subsystem, computer, management controller, storage controller, etc.) may include a processor (such as a microprocessor, CPU, ASIC, FPGA, etc.) and modules, code, and/or logic (soft or hard) integrated with and/or executable by the processor to execute the steps of the method 500 or portions thereof. In another embodiment, a computer program product may include a computer readable storage medium having program code embodied therewith, the program code readable/executable by a processor to execute the method 500 or portions thereof.

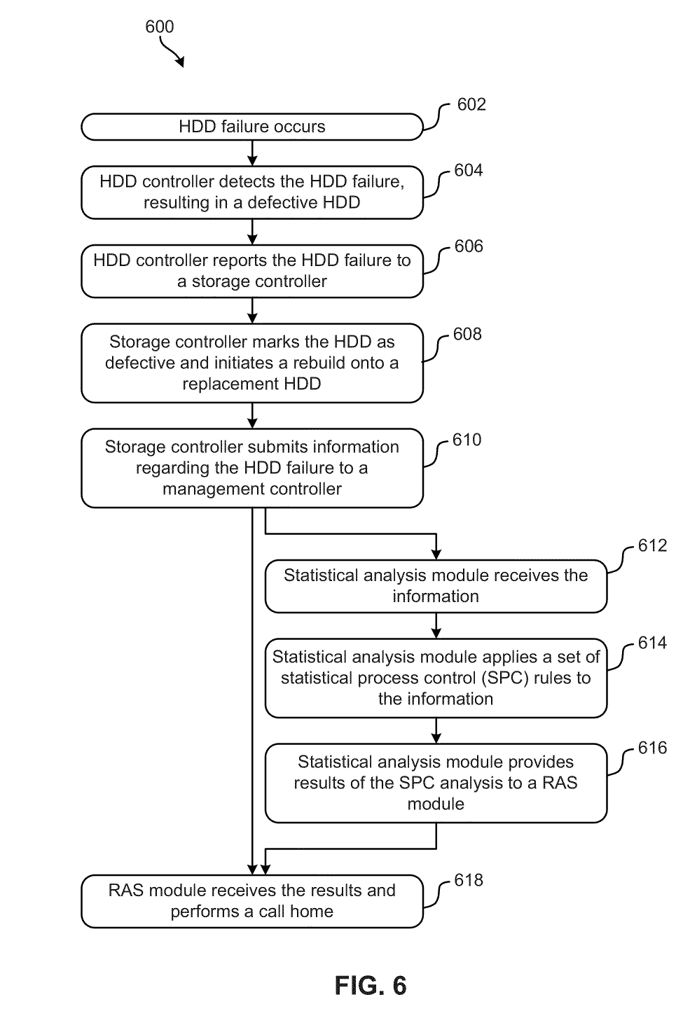

Now referring to FIG. 6, a flowchart of a method 600 for HDD failure detection is shown, according to one embodiment. The method 600 may be performed in accordance with the present invention in any of the environments depicted in FIGS. 1-4, among others, in various embodiments. Of course, more or less operations than those specifically described in FIG. 6 may be included in method 600, as would be understood by one of skill in the art upon reading the present descriptions.

Each of the steps of the method 600 may be performed by any suitable component of the operating environment. For example, in one embodiment, the method 600 may be partially or entirely performed by a storage controller, a management controller, a statistical analysis module, a RAS module, a processor (such as an ASIC, a FPGA, a CPU, etc.) embodied in a computer or device, a host or server connected to an internal or external network, etc.

As shown in FIG. 6, method 600 may initiate with operation 602, where a HDD failure occurs. This failure may be due to any failure mechanism within or external to a functioning HDD.

In operation 604, the HDD controller detects the HDD failure which results in a defective HDD.

In operation 606, the HDD controller reports the HDD failure to a storage controller. The storage controller may receive failure information from a plurality of HDDs under its control.

The detection of the failure may be based on any indicia of failure which is described herein or others known in the art. A non-exhaustive list of possible conditions or information which may be indicative of a storage device failure include, but are not limited to: changes in temperature or humidity and/or detection of a corrosive environment; mechanical impacts such as vibration, shock, sound (for fire suppression units), etc.; electrical impacts such as leakage currents, voltage spikes, detection of high voltage, power outages, etc.; machine internal events, such as problems with the disk drive module (DDM) slot, backplane, expansion unit, expansion rack, etc.; HDD manufacturing driven failures such as the HDD being from a problematic vintage based on date of manufacture; HDD firmware driven events; HDD transport issues, etc.

In operation 608, the storage controller marks the HDD as defective and initiates a rebuild onto a replacement HDD. The replacement HDD may be selected from a pool of available HDDs such that it most closely matches the characteristics of the failed HDD, such as size, speed, redundancy, manufacturer, model, etc.

In operation 610, the storage controller submits information regarding the HDD failure to a management controller. The management controller may manage a plurality of HDD controllers (and thus the HDDs themselves). In turn, the management controller may provide the information to other modules or devices, such as a statistical analysis module, in one approach.

The information may include, in various approaches, information relating to the storage device which experienced the failure event and any system and/or subsystem thereof, such as: storage device position (relative to other storage devices, in a storage subsystem, in the storage system, and in a RAID or array), storage device manufacturer and/or vendor, manufacturing information (including manufacturing date, batch and/or serial number, etc.), storage device failure code, storage device disk pool information, storage device install timestamp, storage device failed timestamp, etc.

In operation 612, the statistical analysis module receives the information from the management controller (or from the HDD controller) in any suitable format.

In operation 614, the statistical analysis module applies a set of statistical process control (SPC) rules to the information. This application of SPC rules may determine whether one or more parameters are statistically abnormal (outside of a predetermined allowable range). When the failure event is determined to be statistically abnormal, an operator may be informed of the failure event in order to allow the operator to investigate the failed HDD more thoroughly if deemed appropriate.

In operation 616, the statistical analysis module provides results of the SPC analysis to a RAS module for troubleshooting of any future HDD failures or to prevent HDD failures based on the SPC analysis.

In operation 618, the RAS module receives the results and performs a call home. In response to the communication, the operator and/or a field service technician is informed that a HDD has failed and needs to be replaced.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A system, comprising a processor and logic integrated with and/or executable by the processor, the logic being configured to:
detect a failure event indicating possible failure of a storage device;
initiate a rebuild for the storage device which experienced the failure event;
receive information about the storage device which experienced the failure event; and
apply a set of statistical process control rules to the information to determine whether the failure event is statistically abnormal.

2. The system as recited in claim 1, wherein the storage device is a hard disk drive, and wherein the failure event includes a change in temperature and/or humidity and/or detection of a corrosive environment.

3. The system as recited in claim 1, wherein the logic is further configured to:
report the failure event to at least one of: a storage controller which is configured to manage the storage device, a management controller which manages a plurality of storage controllers, a reliability, availability, serviceability (RAS) module coupled to the management controller, and a statistical analysis module coupled to the management controller; and
submit the information about the storage device which experienced the failure event to the RAS module and/or the statistical analysis module.

4. The system as recited in claim 1, wherein the information about the storage device which experienced the failure event comprises at least one of: storage device position, storage device manufacturer, manufacturing date, batch and/or serial number, storage device disk pool information, storage device install timestamp, and storage device failure code and failed timestamp if storage device has actually failed.

5. The system as recited in claim 1, wherein the rebuild is initiated by one of: a storage controller which is configured to manage the storage device which experienced the failure event within a storage subsystem, a management controller which manages a plurality of storage controllers including the storage controller which is configured to manage the storage device which experienced the failure event, a reliability, availability, serviceability (RAS) module coupled to the management controller, and a statistical analysis module coupled to the management controller.

6. The system as recited in claim 5, wherein the rebuild transfers and/or copies all data from the storage device which experienced the failure event to another storage device to ensure that the data is accessible even when the storage device which experienced the failure event eventually fails.

7. The system as recited in claim 1, wherein the set of statistical process control rules are applied by a statistical analysis module coupled to a management controller which manages a plurality of storage controllers including a storage controller which is configured to manage the storage device which experienced the failure event.

8. The system as recited in claim 1, wherein the logic is further configured to mark the storage device which experienced the failure event as defective and remove it from service when the failure event is determined to be abnormal.

9. A computer program product for providing early warning of storage device failure, the computer program product comprising a computer readable storage medium having program code embodied therewith, the program code readable/executable by a processor to:
detect a failure event indicating possible failure of a storage device;
initiate a rebuild for the storage device which experienced the failure event;
receive information about the storage device which experienced the failure event; and
apply a set of statistical process control rules to the information to determine whether the failure event is statistically abnormal.

10. The computer program product as recited in claim 9, wherein the storage device is a hard disk drive, and wherein the failure event includes a change in temperature and/or humidity and/or detection of a corrosive environment.

11. The computer program product as recited in claim 9, wherein the program code is further readable/executable by the processor to:
report the failure event to at least one of: a storage controller which is configured to manage the storage device, a management controller which manages a plurality of storage controllers, a reliability, availability, serviceability (RAS) module coupled to the management controller, and a statistical analysis module coupled to the management controller; and
submit the information about the storage device which experienced the failure event to the RAS module and/or the statistical analysis module.

12. The computer program product as recited in claim 9, wherein the information about the storage device which experienced the failure event comprises at least one of: storage device position, storage device manufacturer, manufacturing date, batch and/or serial number, storage device disk pool information, storage device install timestamp, and storage device failure code and failed timestamp if storage device has actually failed.

13. The computer program product as recited in claim 9, wherein the rebuild is initiated by one of: a storage controller which is configured to manage the storage device which experienced the failure event within a storage subsystem, a management controller which manages a plurality of storage controllers including the storage controller which is configured to manage the storage device which experienced the failure event, a reliability, availability, serviceability (RAS) module coupled to the management controller, and a statistical analysis module coupled to the management controller.

14. The computer program product as recited in claim 13, wherein the rebuild transfers and/or copies all data from the storage device which experienced the failure event to another storage device to ensure that the data is accessible even when the storage device which experienced the failure event eventually fails.

15. The computer program product as recited in claim 9, wherein the set of statistical process control rules are applied by a statistical analysis module coupled to a management controller which manages a plurality of storage controllers including a storage controller which is configured to manage the storage device which experienced the failure event.

16. The computer program product as recited in claim 9, wherein the program code is further readable/executable by the processor to mark the storage device which experienced the failure event as defective and remove it from service when the failure event is determined to be abnormal.

17. A method for providing early warning of storage device failure, the method comprising:
detecting a failure event indicating possible failure of a storage device, wherein the storage device is a hard disk drive;
initiating a rebuild for the storage device which experienced the failure event;
receiving information about the storage device which experienced the failure event; and
applying a set of statistical process control rules to the information to determine whether the failure event is statistically abnormal using a statistical analysis module coupled to a management controller which manages a plurality of storage controllers including a storage controller which is configured to manage the storage device which experienced the failure event,
wherein the information about the storage device which experienced the failure event comprises at least one of: storage device position, storage device manufacturer, manufacturing date, batch and/or serial number, storage device disk pool information, storage device install timestamp, and storage device failure code and failed timestamp if the storage device has actually failed.

18. The method as recited in claim 17, wherein the failure event includes a change in temperature and/or humidity and/or detection of a corrosive environment.

19. The method as recited in claim 17, further comprising:
reporting the failure event, using the storage controller, to at least one of: the management controller, a reliability, availability, serviceability (RAS) module coupled to the management controller, and a statistical analysis module coupled to the management controller;
submitting the information about the storage device which experienced the failure event to the RAS module and/or the statistical analysis module using the storage controller; and
marking the storage device which experienced the failure event as defective and removing it from service when the failure event is determined to be abnormal.

20. The method as recited in claim 17, wherein the rebuild is initiated by one of: the storage controller, the management controller, the RAS module, and the statistical analysis module, wherein the rebuild transfers and/or copies all data from the storage device which experienced the failure event to another storage device to ensure that the data is accessible even when the storage device which experienced the failure event eventually fails.
